(19) United States
(12) Patent Application Publication
(10) Pub. No.: US 2025/0055017 A1
(43) Pub. Date: Feb. 13, 2025

(54) APPARATUS FOR AND METHOD OF MANUFACTURING BATTERY ELEMENT

(71) Applicant: KOMATSU NTC LTD., Toyama (JP)

(72) Inventor: Takamitsu INOUE, Nanto-city (JP)

(21) Appl. No.: 18/756,436

(22) Filed: Jun. 27, 2024

(30) Foreign Application Priority Data
Aug. 9, 2023 (JP) 2023-130242

(51) Int. Cl. H01M 10/04

(52) U.S. Cl. CPC H01M 10/0431

(57) ABSTRACT

A manufacturing apparatus includes a winding mechanism, a cutting device, an upstream chuck, a downstream chuck, a starting end position sensor, and a correction actuator. The cutting device cuts the electrode sheet. The upstream chuck clamps the electrode sheet in a position located upstream of the cutting device. The downstream chuck clamps the electrode sheet in a position located downstream of the cutting device. The downstream chuck is moved in a feeding direction oriented toward the winding mechanism, while clamping the starting end, so as to feed the starting end to a position for starting winding by the winding mechanism. The starting end position sensor detects a position of the starting end in a width direction. The correction actuator adjusts a position of the downstream chuck to correct displacement in position of the starting end with respect to the winding mechanism in the width direction.

### CROSS-REFERENCE TO RELATED APPLICATIONS

This application claims priority to Japanese Patent Application No. 2023-130242 filed on Aug. 9, 2023, the disclosure of which is hereby incorporated herein by reference in its entirety.

### BACKGROUND

### Field of the Invention

The present disclosure relates to an apparatus for and a method of manufacturing a battery element obtained by winding an electrode sheet having a strip shape.

### BACKGROUND INFORMATION

There has been conventionally known an apparatus for manufacturing a battery element by winding an electrode sheet having a strip shape. For example, Publication of Japan Patent No. 5595309 discloses a winding device that winds an electrode sheet and a separator at intervals of a predetermined length. The winding device includes a rotor, a cutting means, a chuck, a laser sensor, and an actuator for correction.

The rotor winds an electrode sheet thereabout. The cutting means includes a blade portion and a base portion. The cutting means cuts the electrode sheet at a boundary between a terminal end of a part of the electrode sheet wound about the rotor and a starting end of a subsequent part of the electrode sheet to be wound about the rotor. The chuck is configured to clamp the electrode sheet in a position located upstream of the cutting means. The chuck is moved toward the rotor, while clamping the starting end of the to-be-wound part of the electrode sheet, whereby the starting end of the to-be-wound part of the electrode sheet is fed to the rotor. The laser sensor detects a position of the starting end of the to-be-wound part of the electrode sheet. The actuator for correction adjusts a position of the chuck to correct displacement in width-directional position of the starting end of the to-be-wound part of the electrode sheet with respect to the rotor based on the detected position of the starting end of the to-be-wound part of the electrode sheet.

### SUMMARY

In the winding device described above, the chuck is disposed upstream of the cutting means when the electrode sheet is cut by the cutting means. Because of this, when the chuck is moved toward the rotor, while clamping the starting end, the blade portion and the base portion of the cutting means are moved to retraction positions away from each other up and down. The chuck is moved to the rotor via a space between the blade portion and the base portion.

In the winding device described above, the blade portion and the base portion of the cutting means are moved by a large amount to the retraction positions, respectively, to enable the chuck to pass through the space between the blade portion and the base portion. Because of this, increase in size of the winding device is inevitable. Besides, a large distance is produced between the blade portion and the base portion; hence, positional alignment between the blade portion and the base portion is made difficult. When positional alignment between the blade portion and the base portion is made with low accuracy, degradation in quality of manufacturing the battery element is inevitable. It is an object of the present disclosure to achieve not only reduction in size of an apparatus for manufacturing a battery element but also enhancement in quality of manufacturing the battery element.

A manufacturing apparatus according to an aspect of the present disclosure relates to an apparatus for manufacturing a battery element obtained by winding an electrode sheet having a strip shape. The manufacturing apparatus includes a winding mechanism, a cutting device, an upstream chuck, a downstream chuck, a starting end position sensor, and a correction actuator. The winding mechanism winds the electrode sheet. The cutting device cuts the electrode sheet at a boundary between a terminal end of a wound part of the electrode sheet and a starting end of a subsequent part of the electrode sheet to be wound by the winding mechanism. The upstream chuck is configured to clamp the electrode sheet in a position located upstream of the cutting device. The downstream chuck is configured to clamp the electrode sheet in a position located downstream of the cutting device. The downstream chuck is moved in a feeding direction oriented toward the winding mechanism while clamping the starting end so as to feed the starting end to a position for starting winding by the winding mechanism. The starting end position sensor detects a position of the starting end in a width direction. The correction actuator adjusts a position of the downstream chuck to correct displacement in position of the starting end with respect to the winding mechanism in the width direction.

A manufacturing method according to another aspect of the present disclosure relates to a method of manufacturing a battery element obtained by winding an electrode sheet having a strip shape. The manufacturing method includes winding the electrode sheet by a winding mechanism, cutting the electrode sheet by a cutting device at a boundary between a terminal end of a wound part of the electrode sheet and a starting end of a subsequent part of the electrode sheet to be wound by the winding mechanism, clamping the electrode sheet by an upstream chuck in a position located upstream of the cutting device, clamping the electrode sheet by a downstream chuck in a position located downstream of the cutting device, moving the downstream chuck in a feeding direction oriented toward the winding mechanism while the starting end is clamped by the downstream chuck so as to feed the starting end to a position for starting winding by the winding mechanism, detecting a position of the starting end in a width direction, and adjusting a position of the downstream chuck to correct displacement in position of the starting end with respect to the winding mechanism in the width direction.

According to the present disclosure, the downstream chuck clamps the electrode sheet in the position located downstream of the cutting device. Therefore, when the downstream chuck feeds the starting end to the winding mechanism, even without retracting the cutting device by a large amount, such a situation is avoided that the downstream chuck interferes with the cutting device. Because of this, it is made possible to achieve not only reduction in size of the apparatus for manufacturing the battery element but also enhancement in quality of manufacturing the battery element.

### BRIEF DESCRIPTION OF THE DRAWINGS

FIG. 1 is a schematic diagram of a configuration of an apparatus for manufacturing a battery element.

FIG. 2 is a partial closeup cross-sectional view of the battery element.

FIG. 3 is a schematic side view of a configuration of a winding mechanism and a first supply device.

FIG. 4 is a schematic top view of the configuration of the winding mechanism and the first supply device.

FIG. 5A is a diagram showing part of a series of motions performed by the first supply device in a cutting step.

FIG. 5B is a diagram showing part of the series of motions performed by the first supply device in the cutting step.

FIG. 5C is a diagram showing part of the series of motions performed by the first supply device in the cutting step.

FIG. 5D is a diagram showing part of the series of motions performed by the first supply device in the cutting step.

FIG. 6A is a diagram showing part of a series of motions performed by the first supply device in an electrode supplying step.

FIG. 6B is a diagram showing part of the series of motions performed by the first supply device in the electrode supplying step.

FIG. 6C is a diagram showing part of the series of motions performed by the first supply device in the electrode supplying step.

FIG. 6D is a diagram showing part of the series of motions performed by the first supply device in the electrode supplying step.

### DETAILED DESCRIPTION OF EMBODIMENTS

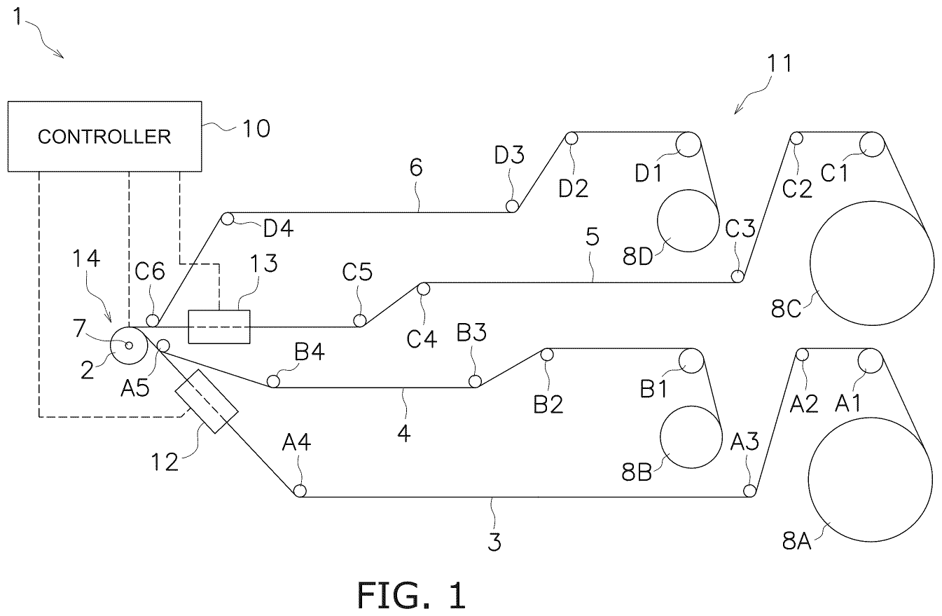

An apparatus for manufacturing a battery element according to a preferred embodiment will be hereinafter explained with reference to drawings. FIG. 1 is a schematic view of a configuration of an apparatus 1 for manufacturing a battery element 2. In the present preferred embodiment, the battery element 2 is used for, e.g., a lithium-ion battery. As shown in FIG. 1, the battery element 2 is formed by tubularly winding a positive electrode sheet 3, a first separator sheet 4, a negative electrode sheet 5, and a second separator sheet 6.

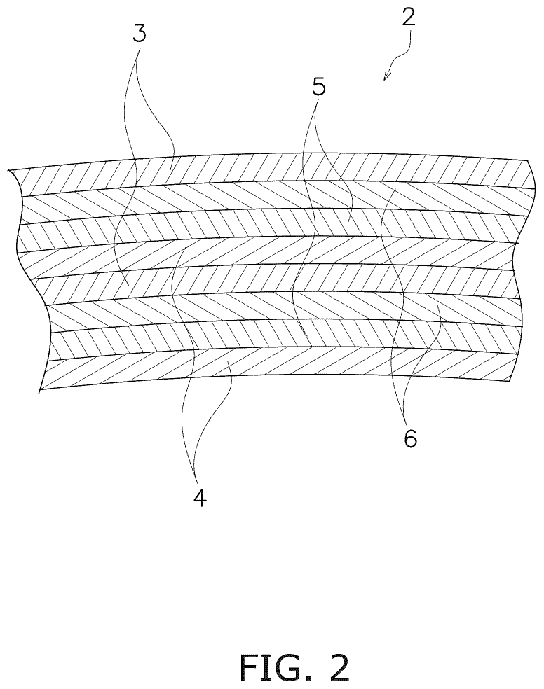

The positive electrode sheet 3, the first separator sheet 4, the negative electrode sheet 5, and the second separator sheet 6 each have a strip shape. FIG. 2 is a partial closeup cross-sectional view of the battery element 2. As shown in FIG. 2, the battery element 2 includes the positive electrode sheet 3, the first separator sheet 4, the negative electrode sheet 5, and the second separator sheet 6 as layers laminated each other. The positive and negative electrode sheets 3 and 5 are thin metallic plates applied with an active material. The first and second separator sheets 4 and 6 are made of an insulator such as polypropylene. Each of the layers of first and second separator sheets 4 and 6 is disposed between each pair of adjacent layers of positive and negative electrode sheets 3 and 5 to prevent short-circuit from occurring therebetween.

As shown in FIG. 1, the manufacturing apparatus 1 manufactures the battery element 2 by winding the positive electrode sheet 3, the first separator sheet 4, the negative electrode sheet 5, and the second separator sheet 6 about a winding core 7, with the sheets 3, 4, 5, and 6 being overlapped with each other. The positive electrode sheet 3 is unwound from a positive electrode roll 8A. The positive electrode roll 8A is made of the positive electrode sheet 3 tubularly wound. The first separator sheet 4 is unwound from a first separator roll 8B. The first separator roll 8B is made of the first separator sheet 4 tubularly wound. The negative electrode sheet 5 is unwound from a negative electrode roll 8C. The negative electrode roll 8C is made of the negative electrode sheet 5 tubularly wound. The second separator sheet 6 is unwound from a second separator roll 8D. The second separator roll 8D is made of the second separator sheet 6 tubularly wound.

The manufacturing apparatus 1 includes a controller 10, a guide mechanism 11, a first supply device 12, a second supply device 13, and a winding mechanism 14. The controller 10 controls the manufacturing apparatus 1. The controller 10 includes, e.g., a processor and a storage device. The controller 10 controls the first supply device 12, the second supply device 13, and the winding mechanism 14 based on programs and data stored therein.

The guide mechanism 11 leads the positive electrode sheet 3, unwound from the positive electrode roll 8A, to the winding mechanism 14. The guide mechanism 11 leads the first separator sheet 4, unwound from the first separator roll 8B, to the winding mechanism 14. The guide mechanism 11 leads the negative electrode sheet 5, unwound from the negative electrode roll 8C, to the winding mechanism 14. The guide mechanism 11 leads the second separator sheet 6, unwound from the second separator roll 8D, to the winding mechanism 14. The positive electrode roll 8A, the first separator roll 8B, the negative electrode roll 8C, and the second separator roll 8D are each rotatably supported.

The guide mechanism 11 includes a plurality of guide rollers A1 to A5, B1 to B4, C1 to C6, and D1 to D4. The plural guide rollers A1 to A5, B1 to B4, C1 to C6, and D1 to D4 are each rotatably supported.

The guide rollers A1 to A4 guide the positive electrode sheet 3 unwound from the positive electrode roll 8A. The guide rollers B1 to B4 guide the first separator sheet 4 unwound from the first separator roll 8B. The guide roller A5 leads the positive electrode sheet 3 and the first separator sheet 4 to the winding mechanism 14. The guide rollers C1 to C5 guide the negative electrode sheet 5 unwound from the negative electrode roll 8C. The guide rollers D1 to D4 guide the second separator sheet 6 unwound from the second separator roll 8D. The guide roller C6 leads the negative electrode sheet 5 and the second separator sheet 6 to the winding mechanism 14.

It should be noted that the guide mechanism 11 includes a tension controlling mechanism (not shown in the drawings). The tension controlling mechanism applies tensions to the positive electrode sheet 3, the first separator sheet 4, the negative electrode sheet 5, and the second separator sheet 6, respectively. The tension controlling mechanism includes, e.g., a dancer roller.

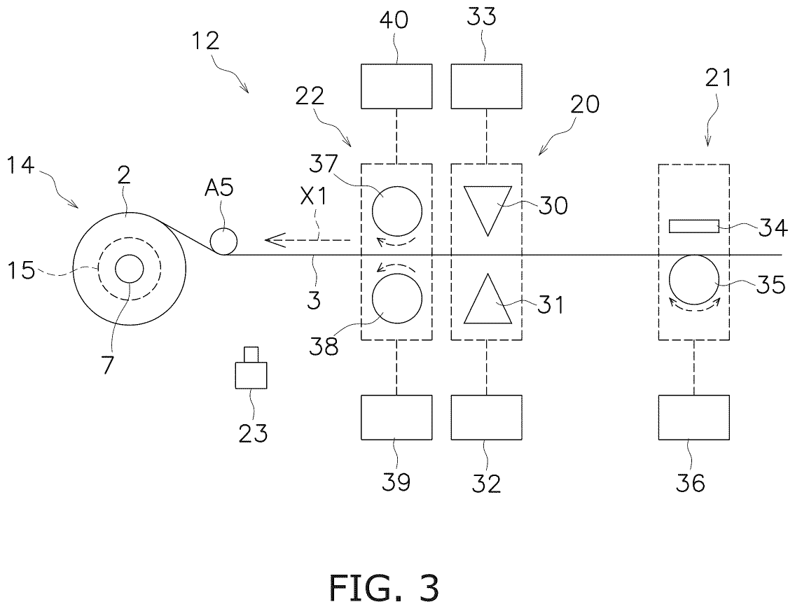

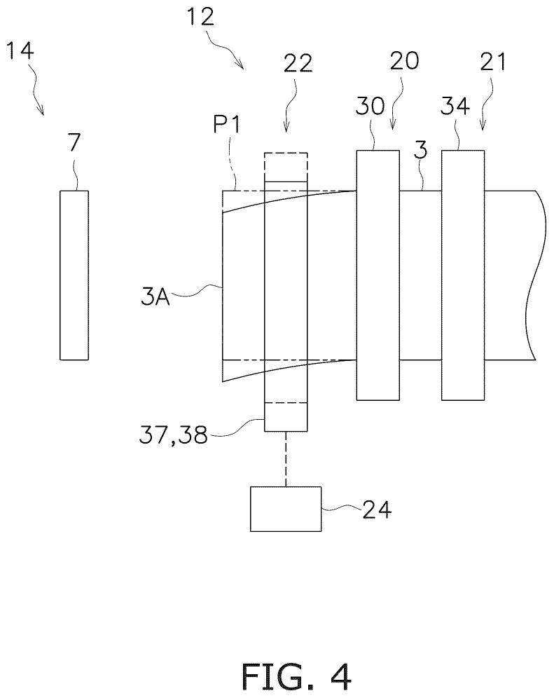

FIG. 3 is a schematic view of a configuration of the winding mechanism 14 and the first supply device 12. FIG. 4 is a top view of the winding mechanism 14 and the first supply device 12. As shown in FIG. 3, the winding mechanism 14 includes a winding actuator 15. The winding actuator 15 includes, e.g., a motor. Alternatively, the winding actuator 15 may include another type of actuator. The winding actuator 15 rotates the winding core 7 to wind the positive electrode sheet 3, the first separator sheet 4, the negative electrode sheet 5, and the second separator sheet 6 about the winding core 7. It should be noted that in FIG. 3, the first separator sheet 4, the negative electrode sheet 5, and the second separator sheet 6 are omitted in illustration.

The first supply device 12 supplies the positive electrode sheet 3 to the winding mechanism 14. As shown in FIGS. 3 and 4, the first supply device 12 includes a cutting device 20, an upstream chuck 21, a downstream chuck 22, a starting end position sensor 23, and a correction actuator 24. The cutting device 20 cuts the positive electrode sheet 3 at a boundary between a terminal end of a part of the positive electrode sheet 3 wound by the winding mechanism 14 and a starting end of a subsequent part of the positive electrode sheet 3 to be wound by the winding mechanism 14. The cutting device 20 includes a blade portion 30, a base portion 31, a first cutting actuator 32, and a second cutting actuator 33.

The blade portion 30 and the base portion 31 are disposed in opposition to each other. The positive electrode sheet 3 extends through a space between the blade portion 30 and the base portion 31. The blade portion 30 and the base portion 31 are each movable in an up-and-down direction. The term “up-and-down direction” means a direction oriented perpendicular to the positive electrode sheet 3. Besides, the blade portion 30 and the base portion 31 are each movable in both a feeding direction of the positive electrode sheet 3 and a direction oriented reverse to the feeding direction. As depicted with arrow X1 in FIG. 3, the feeding direction refers to a direction oriented toward the winding mechanism 14 from the first supply device 12.

The first cutting actuator 32 moves the blade portion 30 and the base portion 31 to a cutting position and a retraction position. In the cutting position, the blade portion 30 and the base portion 31 cut the positive electrode sheet 3. In the retraction position, the blade portion 30 and the base portion 31 are remote from the positive electrode sheet 3 in the up-and-down direction. The first cutting actuator 32 includes, e.g., a motor or cylinder.

The second cutting actuator 33 moves the blade portion 30 and the base portion 31 in the feeding direction and the direction oriented reverse thereto. The second cutting actuator 33 includes, e.g., a motor or cylinder. Alternatively, the first and second cutting actuators 32 and 33 may each include another type of actuator.

The upstream chuck 21 is configured to clamp the positive electrode sheet 3 in a position located upstream of the cutting device 20. The upstream chuck 21 includes a pad 34, an upstream roller 35, and a chuck actuator 36. The pad 34 and the upstream roller 35 are disposed upstream of the cutting device 20. The pad 34 and the upstream roller 35 are disposed in opposition to each other. The positive electrode sheet 3 extends through a space between the pad 34 and the upstream roller 35. The pad 34 is movable in the up-and-down direction.

The upstream roller 35 supports the positive electrode sheet 3. The upstream roller 35 is rotatably supported. The upstream roller 35 is rotatable in both a forward rotational direction corresponding to the feeding direction and a reverse rotational direction oriented reverse to the forward rotational direction. The chuck actuator 36 moves the pad 34 to a clamping position and an unclamping position. When located in the clamping position, the pad 34 clamps the positive electrode sheet 3 together with the upstream roller 35. When located in the unclamping position, the pad 34 is remote from the positive electrode sheet 3 in the up-and-down direction. The chuck actuator 36 includes, e.g., a motor or cylinder. Alternatively, the chuck actuator 36 may include another type of actuator.

The downstream chuck 22 is configured to clamp the positive electrode sheet 3 in a position located downstream of the cutting device 20. While clamping the starting end of the to-be-wound part of the positive electrode sheet 3, the downstream chuck 22 is moved in the feeding direction so as to feed the starting end to a position for staring winding by the winding mechanism 14. The downstream chuck 22 includes a pair of downstream rollers 37 and 38, a first chuck actuator 39, and a second chuck actuator 40.

The pair of downstream rollers 37 and 38 is disposed downstream of the cutting device 20. The pair of downstream rollers 37 and 38 is disposed in opposition to each other. The positive electrode sheet 3 extends through a space between the pair of downstream rollers 37 and 38. The pair of downstream rollers 37 and 38 is each movable in the up-and-down direction. Besides, the pair of downstream rollers 37 and 38 is movable in both the feeding direction and the direction oriented reverse thereto. The pair of downstream rollers 37 and 38 is each rotatably supported. The pair of downstream rollers 37 and 38 is each rotatable only in the forward rotational direction corresponding to the feeding direction and is therefore non-rotatable in the reverse rotational direction oriented reverse thereto.

The first chuck actuator 39 moves the pair of downstream rollers 37 and 38 to the clamping position and the unclamping position. When located in the clamping position, the pair of downstream rollers 37 and 38 clamps the positive electrode sheet 3. When located in the unclamping position, the pair of downstream rollers 37 and 38 is remote from the positive electrode sheet 3 in the up-and-down direction. The first chuck actuator 39 includes, e.g., a motor or cylinder.

The second chuck actuator 40 moves the pair of downstream rollers 37 and 38 in the feeding direction and the direction oriented reverse thereto. The second chuck actuator 40 includes, e.g., a motor or cylinder. Alternatively, the first and second chuck actuators 39 and 40 may each include another type of actuator.

The starting end position sensor 23 detects a position of a starting end 3A of the to-be-wound part of the positive electrode sheet 3 in a width direction of the positive electrode sheet 3. The starting end position sensor 23 is disposed downstream of the cutting device 20. The starting end position sensor 23 is disposed between the cutting device 20 and the winding mechanism 14 in the feeding direction of the positive electrode sheet 3. The starting end position sensor 23 is, e.g., a displacement sensor of a laser type. Alternatively, the starting end position sensor 23 may be a displacement sensor of another type (a magnetic type, an ultrasonic type, etc.).

The correction actuator 24 adjusts the position of the downstream chuck 22 to correct displacement in width directional position of the starting end 3A with respect to the winding mechanism 14. As shown in FIG. 4, the pair of downstream rollers 37 and 38 is movable in the width direction of the positive electrode sheet 3. The correction actuator 24 moves the pair of downstream rollers 37 and 38 in the width direction.

For example, as shown in FIG. 4, when the starting end 3A of the to-be-wound part of the positive electrode sheet 3 is displaced from an appropriate position P1 in the width direction, the starting end position sensor 23 detects both the displacement direction and displacement amount of the starting end 3A. The correction actuator 24 corrects the displacement in width directional position of the starting end 3A by moving the pair of downstream rollers 37 and 38, clamping the starting end 3A, by the displacement amount in a direction oriented opposite to the displacement direction.

The actuators 15, 24, 32, 33, 36, 39, and 40 described above and the starting end position sensor 23 are connected to the controller 10 to be communicable therebetween. The controller 10 transmits command signals to the actuators 15, 24, 32, 33, 36, 39, and 40 to control the actuators 15, 24, 32, 33, 36, 39, and 40, respectively. Besides, the controller 10 receives a detection signal, indicating the displacement amount and the displacement direction of the starting end 3A, from the starting end position sensor 23. The controller 10 controls the correction actuator 24 based on the displacement amount and the displacement direction of the starting end 3A to correct the displacement in width directional position of the starting end 3A.

The second supply device 13 has a configuration comparable to that of the first supply device 12. The second supply device 13 is controlled by the controller 10 in a manner comparable to the first supply device 12. Accordingly, the battery element 2 is manufactured by the manufacturing apparatus 1. A series of steps of manufacturing the battery element 2 by the manufacturing apparatus 1 will be hereinafter explained.

Fist, the starting end of the first separator sheet 4 and that of the second separator sheet 6 are attached to the winding core 7. Then, the winding core 7 is rotated by the winding mechanism 14, whereby the first and second separator sheets 4 and 6 are wound about the winding core 7.

Next, the starting end 3A of a first electrode sheet and that of a second electrode sheet are fed to a winding start position in an electrode supplying step (to be described). For example, the starting end 3A of the first electrode sheet is sandwiched by one of the first and second separator sheets 4 and 6 in the winding start position, whereas that of the second electrode sheet is sandwiched by the other in the winding start position; then, the first and second electrode sheets are wound about the winding core 7 together with the first and second separator sheets 4 and 6. In this way, a winding step is started.

In the winding step, as shown in FIG. 3, the upstream and downstream chucks 21 and 22 are each located in the unclamping position. Besides, the cutting device 20 is located in the retraction position. In this condition, the manufacturing apparatus 1 causes the winding mechanism 14 to rotate the winding core 7, whereby the positive electrode sheet 3, the first separator sheet 4, the negative electrode sheet 5, and the second separator sheet 6 are wound about the winding core 7, while being overlapped with each other.

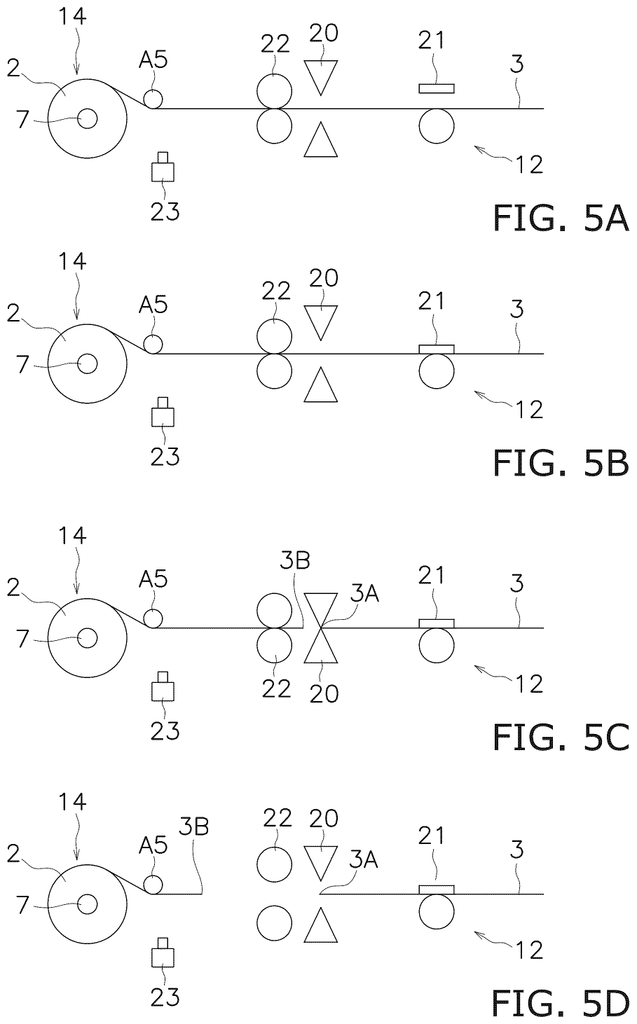

When the positive and negative electrode sheets 3 and 5 are wound by a predetermined length, the manufacturing apparatus 1 ends the winding step and then starts a cutting step. In the cutting step, the winding mechanism 14 is stopped winding the winding core 7. FIGS. 5A to 5D are diagrams showing a series of motions performed by the first supply device 12 in the cutting step. Fist, as shown in FIG. 5A, in the cutting step, the downstream chuck 22 is moved to the clamping position. Accordingly, the downstream chuck 22 clamps the positive electrode sheet 3 in a position located downstream of the cutting device 20.

Next, as shown in FIG. 5B, the upstream chuck 21 is moved to the clamping position. Accordingly, the upstream chuck 21 clamps the positive electrode sheet 3 in a position located upstream of the cutting device 20. As shown in FIG. 5C, the cutting device 20 cuts the positive electrode sheet 3, while the positive electrode sheet 3 is clamped by the upstream and downstream chucks 21 and 22. The cutting device 20 cuts the positive electrode sheet 3 at a boundary between a terminal end 3B of a part of the positive electrode sheet 3 wound by the winding mechanism 14 and the starting end 3A of a subsequent part of the positive electrode sheet 3 to be wound by the winding mechanism 14.

After cutting of the positive electrode sheet 3, as shown in FIG. 5D, the downstream chuck 22 is moved to the unclamping position, whereas the cutting device 20 is moved to the retraction position. The upstream chuck 21 has been clamped the positive electrode sheet 3 in the position located upstream of the cutting device 20. Then, the winding mechanism 14 rotates the winding core 7, whereby the terminal end 3B of the wound part of the positive electrode sheet 3 is wound about the winding core 7. The second supply device 13 operates in a manner comparable to the first supply device 12 described above. Accordingly, the positive electrode sheet 3, the first separator sheet 4, the negative electrode sheet 5, and the second separator sheet 6 are tubularly wound, whereby manufacturing of the battery element 2 is made.

In completion of the cutting step, the manufacturing apparatus 1 replaces the winding core 7, about which the battery element 2 is wound, with another winding core to be used next as the winding core 7. For example, the manufacturing apparatus 1 includes a replacement device (not shown in the drawings) and causes the replacement device to replace the winding core 7, about which the battery element 2 is wound, with the next winding core 7. Accordingly, the next winding core 7 is disposed in the winding mechanism 14.

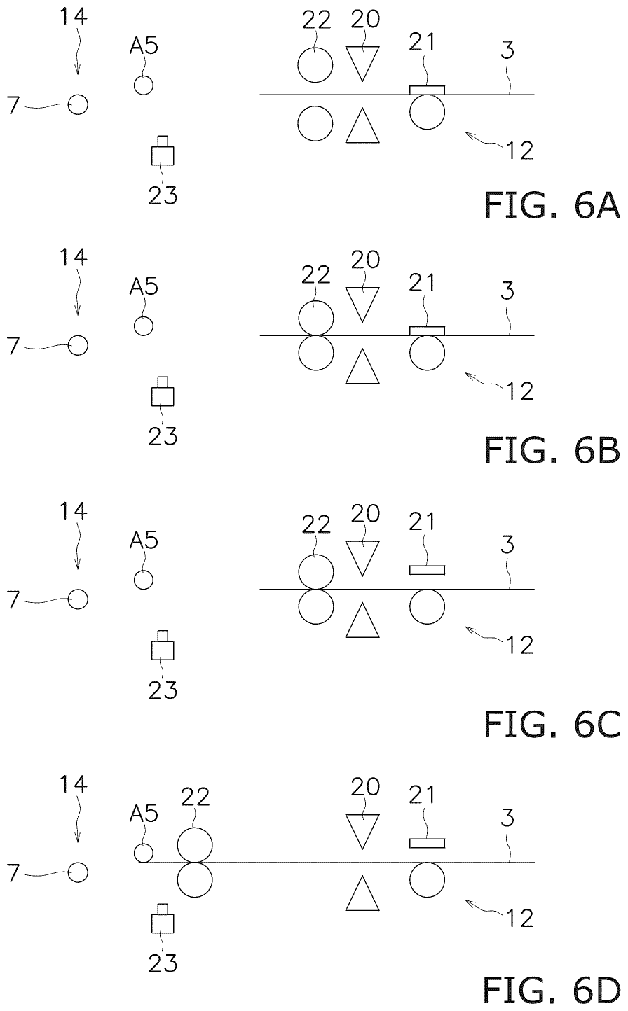

Next, the manufacturing apparatus 1 starts the electrode supplying step. FIGS. 6A to 6D are diagrams showing a series of motions performed by the first supply device 12 in the electrode supplying step. In the electrode supplying step, as shown in FIG. 6A, the cutting device 20 and the downstream chuck 22 are moved in the direction oriented reverse to the feeding direction. In other words, the cutting device 20 and the downstream chuck 22 are moved to approach the upstream chuck 21. Then, as shown in FIG. 6B, the downstream chuck 22 is moved to the clamping position. Accordingly, the downstream chuck 22 clamps the positive electrode sheet 3 in a position located downstream of the cutting device 20.

Next, as shown in FIG. 6C, the upstream chuck 21 is moved to the unclamping position. Accordingly, the positive electrode sheet 3 is unclamped from the upstream chuck 21. Then, as shown in FIG. 6D, the downstream chuck 22 is moved in the feeding direction, while clamping the positive electrode sheet 3. At the same time, the starting end position sensor 23 detects the amount and direction of displacement in width directional position of the starting end 3A. The correction actuator 24 corrects the displacement in width directional position of the starting end 3A based on the amount and direction of displacement. Accordingly, the starting end 3A of the positive electrode sheet 3 is accurately supplied to the winding start position.

The starting end 3A of the first electrode sheet is wound about the winding core 7 together with the first separator sheet 4 in the winding start position. At the same time, the cutting device 20 is moved in the feeding direction and is thereby returned to the position in the winding step shown in FIG. 3. The downstream chuck 22 is moved not only to the unclamping position but also in the direction oriented reverse to the feeding direction and is thereby returned to the position in the winding step shown in FIG. 3. Accordingly, the winding step described above is started anew.

The second supply device 13 also operates in a manner comparable to the first supply device 12 described above. Accordingly, the starting end of the second electrode sheet is supplied to the winding starting position. Then, the starting end of the second electrode sheet is wound about the winding core 7 together with the second separator sheet 6.

In the apparatus 1 for manufacturing the battery element 2 according to the present preferred embodiment explained above, the downstream chuck 22 clamps the positive electrode sheet 3 in the position located downstream of the cutting device 20 in the electrode supplying step. Because of this, when the downstream chuck 22 feeds the starting end 3A to the winding mechanism 14, even without retracting the cutting device 20 by a large amount, such a situation is avoided that the downstream chuck 22 interferes with the cutting device 20. Accordingly, it is made possible to achieve reduction in size of the apparatus 1 for manufacturing the battery element 2.

For example, as shown in FIG. 3, when the cutting device 20 is located in the retraction position, the distance between the blade portion 30 and the base portion 31 may be smaller than that between the downstream rollers 37 and 38 in the downstream chuck 22. The blade portion 30 and the base portion 31 may be disposed at a short distance as long as prevented from contacting with the positive electrode sheet 3. Because of this, positional alignment between the blade portion 30 and the base portion 31 is enhanced in accuracy, whereby cutting of the positive electrode sheet 3 is enhanced in quality.

In the cutting step, the cutting device 20 cuts the positive electrode sheet 3, while the positive electrode sheet 3 is clamped by the upstream and downstream chucks 21 and 22. Because of this, the positive electrode sheet 3 can be inhibited from bending in cutting. Accordingly, cutting of the positive electrode sheet 3 is enhanced in quality.

The starting end position sensor 23 is disposed downstream of the cutting device 20. Therefore, the starting end position sensor 23 is enabled to detect the width directional position of the starting end 3A in a closer position to the winding core 7 than when disposed upstream of the cutting device 20. Accordingly, correction in positional displacement of the starting end 3A is enhanced in accuracy.

After cutting the positive electrode sheet 3, the cutting device 20 is moved in the direction oriented reverse to the feeding direction before the downstream chuck 22 clamps the starting end 3A. Accordingly, it is made possible not only to inhibit the downstream chuck 22 from interfering with the cutting device 20 but also to reliably produce a margin for the downstream chuck 22 to clamp the positive electrode sheet 3.

Advantageous effects of the manufacturing apparatus 1 according to the present preferred embodiment to be achieved by the first supply device 12 have been explained above; however, it is also made possible for the second supply device 13 to achieve advantageous effects comparable to those achieved by the first supply device 12 described above.

One preferred embodiment of the present invention has been explained above. However, the present invention is not limited to the preferred embodiment described above, and a variety of changes can be made without departing from the gist of the present invention.

The guide mechanism 11, the first supply device 12, the second supply device 13, or the winding mechanism 14 is not limited in configuration to that in the preferred embodiment described above and may be changed. For example, the guide rollers in the guide mechanism 11 are not limited in layout and number to those in the preferred embodiment described above and may be changed.

In the first supply device 12, the downstream chuck 22 is not limited in structure to that in the preferred embodiment described above and may be changed. For example, the downstream chuck 22 may not necessarily clamp the positive electrode sheet 3 with the rollers but may clamp the positive electrode sheet 3 with other members such as pads. The upstream chuck 21 is not limited in structure to that in the preferred embodiment described above and may be changed. For example, the upstream chuck 21 may clamp the positive electrode sheet 3 with other members such as a pair of rollers.

According to the present disclosure, it is made possible to achieve not only reduction in size of an apparatus for manufacturing a battery element but also enhancement in quality of manufacturing the battery element.

What is claimed is:

1. An apparatus for manufacturing a battery element obtained by winding an electrode sheet having a strip shape, the apparatus comprising:
a winding mechanism configured to wind the electrode sheet;
a cutting device configured to cut the electrode sheet at a boundary between
a terminal end of a wound part of the electrode sheet and
a starting end of a subsequent part of the electrode sheet to be wound by the winding mechanism;
an upstream chuck configured to clamp the electrode sheet in a position located upstream of the cutting device;
a downstream chuck configured to
clamp the electrode sheet in a position located downstream of the cutting device, and move in a feeding direction oriented toward the winding mechanism while clamping the starting end so as to feed the starting end to a position in order to start winding by the winding mechanism;
a starting end position sensor configured to detect a position of the starting end in a width direction; and
a correction actuator configured to adjust a position of the downstream chuck to correct displacement in position of the starting end with respect to the winding mechanism in the width direction.

2. The apparatus according to claim 1, wherein
the starting end position sensor is disposed downstream of the cutting device.

3. The apparatus according to claim 1, wherein
the cutting device cuts the electrode sheet, with the electrode sheet being clamped by the upstream and downstream chucks.

4. The apparatus according to claim 1, wherein
the cutting device is movable in both the feeding direction and a reverse direction with respect to the feeding direction.

5. The apparatus according to claim 4, wherein
the cutting device is moved in the reverse direction before the downstream chuck clamps the starting end after cutting the electrode sheet.

6. The apparatus according to claim 1, wherein
the downstream chuck includes a pair of downstream rollers facing each other, and
the pair of downstream rollers is rotatable only in a forward rotational direction corresponding to the feeding direction.

7. The apparatus according to claim 1, wherein
the upstream chuck includes
a pad, and
an upstream roller disposed in opposition to the pad, and
the upstream roller is rotatable in both a forward rotational direction and a reverse direction, the forward rotational direction corresponding to the feeding direction, and the reverse direction oriented opposite to the forward rotational direction.

8. A method of manufacturing a battery element obtained by winding an electrode sheet having a strip shape, the method comprising:
winding the electrode sheet by a winding mechanism;
cutting the electrode sheet by a cutting device at a boundary between
a terminal end of a wound part of the electrode sheet and
a starting end of a subsequent part of the electrode sheet to be wound by the winding mechanism;
clamping the electrode sheet by an upstream chuck in a position located upstream of the cutting device;
clamping the electrode sheet by a downstream chuck in a position located downstream of the cutting device;
moving the downstream chuck in a feeding direction oriented toward the winding mechanism while the starting end is clamped by the downstream chuck so as to feed the starting end to a position for starting winding by the winding mechanism;
detecting a position of the starting end in a width direction; and
adjusting a position of the downstream chuck to correct displacement in position of the starting end with respect to the winding mechanism in the width direction.
